(19) United States
(12) Patent Application Publication
(10) Pub. No.: US 2010/0196228 A1
(43) Pub. Date: Aug. 5, 2010

(54) Floating Pool Chlorinator

(76) Inventor: Jeffrey Efird, Ft. Lauderdale, FL (US)

Correspondence Address: CHRISTOPHER J. VANDAM, P.A., 19600 NE 21 Ct., MIAMI, FL, 33179, US

(21) Appl. No.: 12/364,223

(22) Filed: Feb. 2, 2009

(51) Int. Cl. C02F 1/76

(52) U.S. Cl. 422/265

(57) ABSTRACT

A floating pool chlorinator made of a chemical resistant material comprising a float assembly and basket assembly. Solid pool chemicals are dispersed at a selectively micro-variable rate by engaging the float assembly more or less into the basket assembly thereby exposing to a lesser or greater degree one or more vent holes in the side of the basket assembly. The float assembly is preferably hollow and permanently sealed and dimensioned to float the combined weight of the device and any chemicals placed inside the basket assembly. A child proof lock ring is provided to prevent unwanted exposure to caustic pool chemicals. Optionally, a drain and tether are individually present. The floating pool chlorinator floats in a pool and disperses selected solid pool chemicals dissolved in a pool or spa.

### BACKGROUND OF THE INVENTION

1. Field of the Invention

The present invention relates to chlorination devices to add chemicals to pools, and more particularly, to a floating pool chlorinator that has a micro-adjustable flow rate for accurate solid chemical dispersion in a pool or spa.

2. Description of the Related Art

Several designs for pool chlorinators have been designed in the past. None of them, however, includes a floating pool chlorinator that have a simple and durable child resistant lock, a streamlined profile to avoid catching on skimmer drains, stairs or ladders, micro-adjustable metering, a low chemical indicator, a safety drain means, a permanently sealed float and made from a chemical resistant metal case.

Applicant believes that the closest reference corresponds to U.S. Pat. No. 3,607,103 issued to Kiefer. However, it differs from the present invention because the Kiefer device does not provide for a means to adjust the rate at which chemicals are dispersed into a pool, does not provide for a child resistant locking feature to prevent unwanted contact of chemicals upon a person, does not provide for a means to easily and effectively seal the device for transport or storage, does not provide a drain for safe removal from a pool and uses a less suitable buoyancy material that comes into direct contact with the caustic pool chemicals.

Further distinguishing Kiefer from the present device is Kiefer's use of a tipping design to indicate that chemicals contained within the device have been sufficiently depleted. This feature can cause the Kiefer device to hang up or catch onto pool ladders or get caught into a pool skimmer drain thereby limiting the efficiency of the pool skimmer drain and potentially overworking the pool pump.

U.S. Pat. No. 4,828,805 issued to Connors discloses a floating pool chlorinator with a childproof cap but differs from the present invention in that Connors complicates the child protective by utilizing several series of beads that frictionally engage each other instead of the present device that utilizes a simpler threaded locking ring. The Connors device also does not include a means to determine the amount of chemical in the device to signal that it requires replenishing without removing the device from the pool. The Conner design also imparts upon his device the propensity to get caught on pool ladders, stairs and pool skimmer drains whereas the present invention is designed with streamlined vertical edges that allow it to float past obstructions in a pool.

Other patents are known that each provide a pool chlorinator with many fallible parts, made from materials that fail to resist the caustic pool chemicals, don't have adequate or simple child-proof features, don't adequately drain when removed from a pool causing safety concerns of inadvertent human contact with pool chemicals and don't simply and effectively provide a metering device that is easily adjustable for various conditions and is suitably robust for the pool environment.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a floating pool chlorinator with a minimal number of parts but yet includes a childproof safety feature, safety drain feature, adjustable chemical dispersion rate with a low chemical indicator.

It is another object of this invention to provide a floating pool chlorinator that will not hang up on pool ladders, stairs or pool skimmer drain when floating around a pool.

It is still another object of the present invention to provide a highly robust and long lasting floating pool chlorinator.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of the device with a float assembly separated from a basket assembly.

FIG. 2 shows a perspective view of the device with a lock ring unengaged.

FIG. 3 illustrates a perspective view of the device with the lock ring engaged as it might be in actual use.

FIG. 4 is a representation of a perspective view of the float assembly isolated from the basket assembly.

FIG. 5 is a perspective view of the lock ring isolated from the other elements of the device.

### DETAILED DESCRIPTION OF THE PREFERRED EMBODIMENT

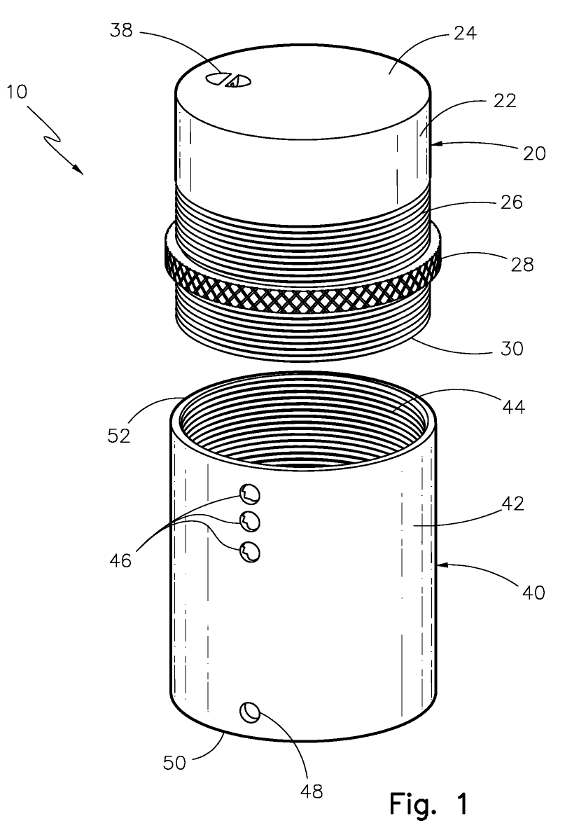

Referring now to the drawings, where the present invention is generally referred to with numeral 10 (sometimes referred to as the device) as shown in FIG. 1, it can be observed that it basically includes a float assembly 20 and a basket assembly 40.

Said float assembly 20 is shown to be comprised of, inter alia, a cylinder 22, a cap 24, threads 26, a lock ring 28, a cap 30 and a tether 38.

Said basket assembly 40 is shown to be comprised of, inter alia, a cylinder 42, threads 44, vents 46, a drain 48, a cap 50 and a seat 52.

Generally, the float assembly 20 is formed of a hollow cylinder 22 enclosed on a first end by cap 24 and enclosed on the opposite end with cap 30. The float assembly 20 is completely sealed and watertight. I a preferred embodiment cap 24 and cap 30 are either permanently welded to or formed integral to the cylinder 22. Ideally, the water displacement created by the volume bounded by the cylinder 22, cap 24 and cap 30 is greater than that of the combined weight of all elements of the invention plus the weight of any chemicals placed inside the basket assembly 40 so that the entire device will float in water.

On the exterior of cylinder 22 are male threads 26. The threads 26 begin on the end of the cylinder 22 adjacent to cap 30 and continue along the cylinder 22 enough to be able to fully engage into threads 44 on the basket assembly 40 or so far as to fully obscure all of vents 46 on the basket assembly 40.

Yet referring to FIG. 1, said lock ring 28 is threaded and thread-able onto threads 26. A tether 38 is optionally provided formed integral to cap 24. Tether 38 provides a feature where a rope or chain may be connected to secure the device 10 to another object such as a handrail or ladder frame pre-existing in the pool. The tether 38 safety feature could, for example, be used to keep the device 10 floating in the deeper end of a pool and away from swimmers in the shallower end of the pool.

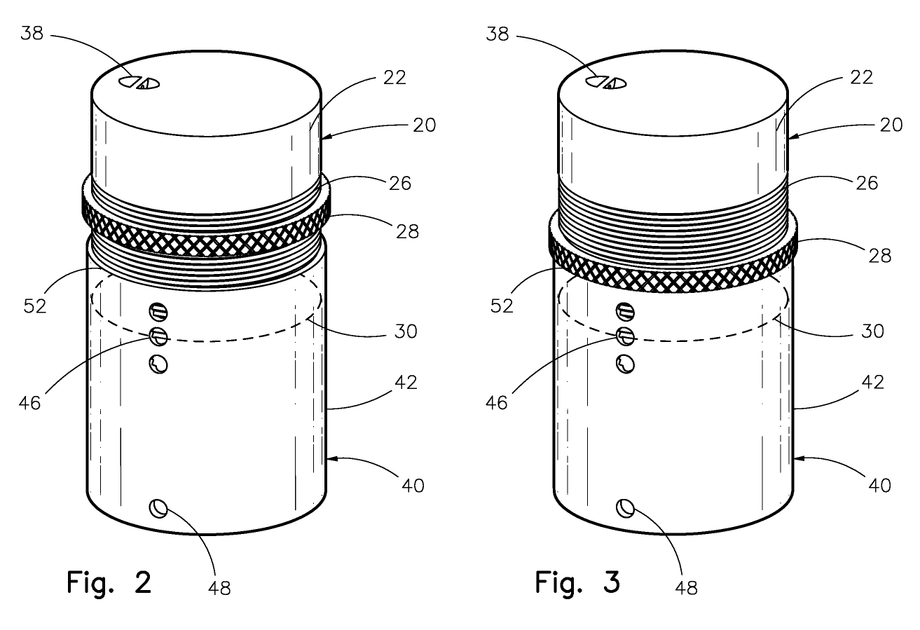

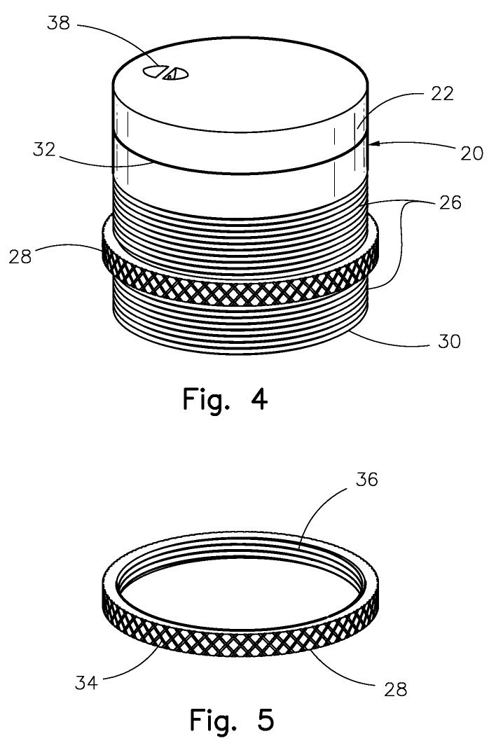

Referring now to FIGS. 2 and 3 where a materially similar device to that demonstrated in FIG. 1 is shown. FIG. 2 depicts the floating pool chlorinator as it is prepared for use. A predetermined amount of solid pool chemicals have been placed inside the basket assembly 40. The float assembly 20 has threads 26 engaged into threads 44 (shown in FIG. 1) to the point where a predetermined depth to obscure or cover a portion of the vents 46. By obscuring more or less of vents 46 with threads 26 the exposure of pool chemicals dissolved inside the basket assembly 40 with the pool may be varied. For example, if the floating pool chlorinator was to be used in small pool or hot tub it would be preferable to obscure two vents 46 and leave one vent 46 open to permit limited communication of dissolved chemicals inside the basket assembly 40 with the pool. Conversely, for example, if used in a larger pool it may be preferable to increase the amount of chemicals dispersed into the pool by not covering any of the vents 46 with the threads 26.

As would be appreciated by one reasonably skilled in the art, the vents 46 could take myriad forms that would permit fluid communication between the pool and dissolved chemicals inside the basket assembly 40. For example, there could be one or more round, oval, rectangular or other shaped vent.

Also as would be appreciated by one reasonably skilled in the art, it would be recognized that threads 26 could alternatively be female where threads 44 on the basket assembly would then be male and the lock ring 28 would then engage threads 44.

Once the float assembly 20 is engaged into the threads 44 of the basket assembly, as the example in FIG. 3 shows, the lock ring 28 may be threaded along threads 26 to rest against seat 52. When lock ring 28 is firmly pressed against seat 52 the movement of threads 26 relative to threads 44 is inhibited and therefore the surface area exposed of vents 46 will remain fixed. Due to the diameter of the lock ring 28 and the force with which the lock ring 28 is pressing against seat 52 a person with less hand strength and smaller hands would be impeded from separating the float assembly 20 from the basket assembly 40. This child proof feature reduces the risk of unwanted human exposure of any chemicals contained inside the basket assembly 40.

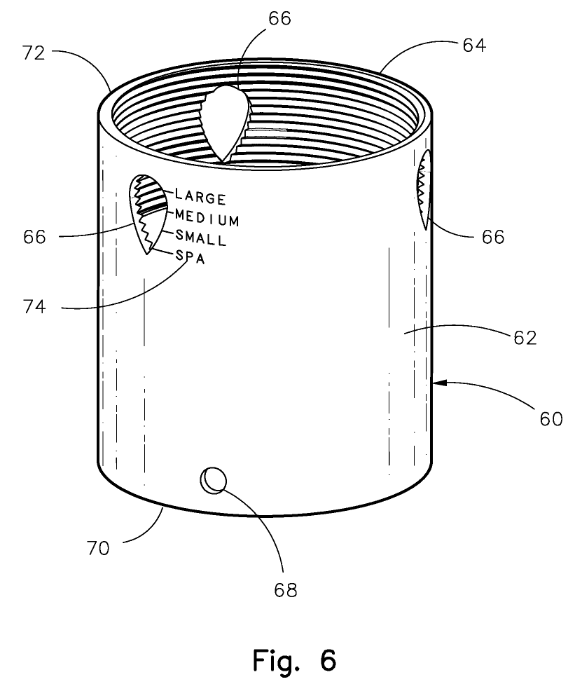

Referring to FIG. 4 an embodiment of the float assembly 20 is shown to further include a ring 32 around the circumference of the cylinder 22. When the floating pool chlorinator is in use floating in a pool the chemicals contained in the basket assembly 40 (as shown in FIG. 3) will act as a ballast and keep the float assembly 20 positioned vertically over the basket assembly 40. As the pool chemicals dissolve and are dispersed into the pool water the net weight of the device and remaining chemicals will be less and therefore more of the float assembly 20 will be exposed above the surface of the pool. The ring 32 is positioned on the float assembly 20 so that when a predetermined amount of chemicals is dispersed from the basket assembly 40 the ring 32 will be exposed slightly above the surface of the pool indicating that the basket assembly 40 should be re-filled with pool chemicals.

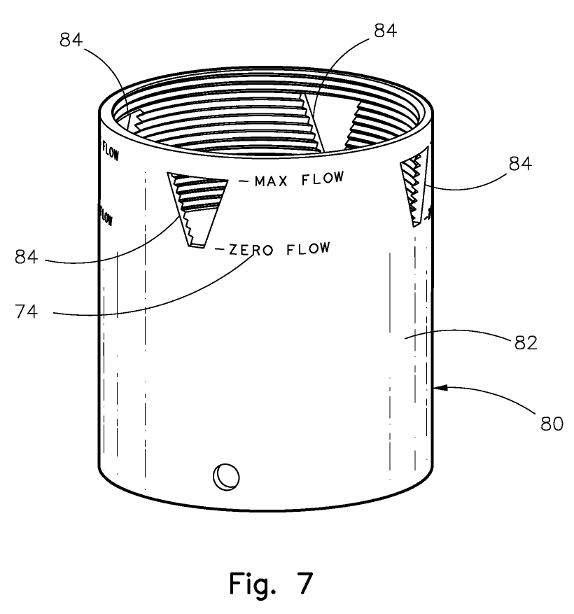

FIG. 5 is a more detailed view of the lock ring 28 shown isolated from the other elements of the device and including, inter alia, a grip 34 and threads 36. Said grip 34 may be positioned on the outside edge of the lock ring 28. Said grip 34 may take the form of knurling, indentations, dimples, grooves or other suitable gripping means commonly in use in the art.

Said threads 36 are preferably complimentary in dimension to threads 26 on the float assembly 26. As described above, the lock ring 28 functions to lock the float assembly 20 relative to the basket assembly 40. Lock ring 28 is preferably constructed from the same material as the float assembly 20 to avoid corrosion or a galvanic reaction.

FIG. 6 demonstrates an alternate embodiment of a basket assembly 60 that is comprised of, inter alia, a cylinder 62, threads 64, a drain 68, a cap 70 and a seat 72, each having analogous function to the similarly named element as described above in the discussion on FIG. 1. FIG. 6 further is comprised of a port 66 and indicator marks 74 that differ from those shown in other embodiments.

The port 66 is tear drop shaped with a larger end nearer the seat 72 and a pointed end nearer the cap 70. The tear drop shape permits the dispersion rate of the device to be fine tuned for a specific volume pool. This avoids over or under treating a pool thereby increasing safety and waste of pool treatment chemicals.

Indicator marks 74 provide a reference mark for how far to engage a float assembly such as the float assembly 20 shown in FIG. 1 into the basket assembly 60 for a given volume pool. In the example shown in FIG. 6 the reference marks could include “Spa”, “Small”, “Medium” and “Large”, referring to the volume of the pool. When assembling the device before deployment in a pool, the float assembly 20 is threaded into the basket assembly 60 to the point where the cap 30 matches up with the appropriate indicator mark 74. This feature aids the user to easily determine the appropriate chemical dispersion rate for a particular pool.

FIG. 7 shows an alternate version of a basket assembly 80 that includes, inter alia, a basket 82, vents 84 and indicator marks 74. The basket assembly 80 is preferably combined with a float assembly 20 such as that shown in FIG. 1. This basket assembly 80 primarily differs from the basket assembly 40 and basket assembly 60 (shown in FIGS. 1 and 6 respectively) due to the configuration and shape of the vents 84. Vents 84 are oriented around the periphery around the top of the basket 82. In the example shown in FIG. 7 there are four equally spaced vents 84. Each of the vents 84 is a trapezoid with the narrower side away from the open end of the basket assembly 80. The trapezoidal shape of the vents 84 allows the chemical dispersion flow rate to be micro-adjustable to accommodate various volumes of pools or spas by finely tuning the open area on each vent 84.

Indicator marks 74 may be located adjacent to any or each of the vents 84 to aid a user in selecting the appropriate vent 84 size opening and thereby micro-adjusting the chemical dispersion rate appropriate for a particular pool or spa.

It should be understood that any of the vents 46, ports 66 or vents 84 may be present in various configurations and shapes. For example, they may be round, oval, rectangular, tear drop, trapezoidal or other shape. There also may be a single or multiple vents 46, ports 66 or vents 84 as may be appropriate for various chemicals being dispersed or for various sized pools or spas. Each of the vents 46, ports 66 or vents 84 shown in the figures are merely an example of alternate configurations.

In any variation of the invention said drain 48, 68 may have a plug, valve or other closure means included to operatively open and close the drain 48, 68. By closing the drain 48, 68 the accuracy of the micro-adjustable flow rate metering may be enhanced to finely calibrate the amount of chemical dispersed into a pool or spa. The drain 48, 68 may then be opened to drain any water contained inside the device when, for example, removing the device from a pool for replenishment of pool chemicals. In all variations of the device the presence of a drain on the case assembly 40, 60, 80 is optional.

A variation of a floating pool chlorinator comprises a float assembly and a basket assembly where said float assembly has an interior volume and is permanently sealed, said basket assembly has an interior volume and is dimensioned to contain a predetermined volume of pool chemicals, said float assembly and said basket assembly being constructed of a corrosion resistant material, said basket assembly having one or more vents around the periphery of said basket assembly permitting liquid communication between the interior and exterior of the basket assembly when the floating pool chlorinator is floating in a pool or spa, said float assembly being sufficiently buoyant to float the combined mass of all elements of the floating pool chlorinator in addition to a predetermined mass of chemicals to be dispersed in a pool or spa, said float assembly removably connectable to said basket assembly by means of threads on the float assembly and basket assembly, said float assembly threadable into said basket assembly to varying degrees so that said vents are covered to a greater or lesser degree to provide a feature to meter the dispensation of chemicals contained in the basket assembly, a locking means that prevents the unintended separation of the float assembly from the basket assembly, and said basket assembly having a drain.

In another variation the floating pool chlorinator is further characterized in that said corrosion resistant material is one of or a combination of any of stainless steel, aluminum, aluminum alloy, plastic, fiberglass or iron alloy.

In another variation the floating pool chlorinator is further characterized in that a means to attach a tether is included on the float assembly or the basket assembly.

In another variation the floating pool chlorinator as disclosed is further characterized in that said float assembly has a reference mark to indicate how deeply the floating pool chlorinator is submerged when floating in a pool or spa.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A floating pool chlorinator comprising a float assembly and a basket assembly where
said float assembly has an interior volume and is permanently sealed
said basket assembly has an interior volume and is dimensioned to contain a predetermined volume of pool chemicals
said float assembly and said basket assembly being constructed of a corrosion resistant material
said basket assembly having one or more vents around the periphery of said basket assembly permitting liquid communication between the interior and exterior of the basket assembly when the floating pool chlorinator is floating in a pool or spa
said float assembly being sufficiently buoyant to float the combined mass of all elements of the floating pool chlorinator in addition to a predetermined mass of chemicals to be dispersed in a pool or spa
said float assembly removably connectable to said basket assembly by means of threads on the float assembly and basket assembly
said float assembly threadable into said basket assembly to varying degrees so that said vents are covered to a greater or lesser degree to provide a feature to meter the dispensation of chemicals contained in the basket assembly
a locking means that prevents the unintended separation of the float assembly from the basket assembly said basket assembly having a drain

2. A floating pool chlorinator as disclosed in claim 1 further characterized in that said corrosion resistant material is one of or a combination of any of stainless steel, aluminum, aluminum alloy, plastic, fiberglass or iron alloy.

3. A floating pool chlorinator as disclosed in claim 1 further characterized in that a means to attach a tether is included on the float assembly or the basket assembly.

4. A floating pool chlorinator as disclosed in claim 1 further characterized in that said float assembly has a reference mark to indicate how deeply the floating pool chlorinator is submerged when floating in a pool or spa.
